(19) United States
(12) Patent Application Publication
(10) Pub. No.: US 2014/0270325 A1
(43) Pub. Date: Sep. 18, 2014

(54) Method for forming synthetic jet actuator and components thereof through insert molding

(71) Applicant: NUVENTIX, INC., Austin, TX (US)

(72) Inventors: Andrew Poynot, Austin, TX (US); Raghavendran Mahalingam, Austin, TX (US); Stephen P. Darbin, Austin, TX (US); Lee M. Jones, Austin, TX (US); Markus Schwickert, Scottsdale, AZ (US); Danny J. Allred, Austin, TX (US); Bouraoui Ben Makhlouf, San Francisco, CA (US)

(73) Assignee: NUVENTIX, INC., Austin, TX (US)

(21) Appl. No.: 14/209,283

(22) Filed: Mar. 13, 2014

Related U.S. Application Data
(60) Provisional application No. 61/800,053, filed on Mar. 15, 2013.
(60) Provisional application No. 61/800,998, filed on Mar. 15, 2013.
(60) Provisional application No. 61/801,702, filed on Mar. 15, 2013.
(60) Provisional application No. 61/802,218, filed on Mar. 15, 2013.
(60) Provisional application No. 61/806,146, filed on Mar. 28, 2013.
(60) Provisional application No. 61/787,831, filed on Mar. 15, 2013.
(60) Provisional application No. 61/805,607, filed on Mar. 27, 2013.
(60) Provisional application No. 61/843,399, filed on Jul. 7, 2013.
(60) Provisional application No. 61/894,685, filed on Oct. 23, 2013.

(51) Int. Cl. H04R 9/02; B29C 45/14; H04R 31/00

(52) U.S. Cl. CPC H04R 9/022; H04R 31/003; B29C 45/1459
USPC 381/397; 264/259

(57) ABSTRACT

A method for making a diaphragm is provided. The method includes providing a first ring (305) having a first diameter and a second ring (307) having a second diameter which is greater than said first diameter, wherein at least one of said first and second rings comprises a first elastomeric material; and overmolding the first and second rings with a second material (303) which is distinct from said first material, thereby forming a diaphragm (301).

This application claims the benefit of U.S. Provisional Application No. 61/800,053, filed Mar. 15, 2013, having the same title, and which is incorporated herein by reference in its entirety; and also claims the benefit of U.S. Provisional Application No. 61/800,998, filed Mar. 15, 2013, entitled “MULTIPLE DIE PACKAGE FOR LED LIGHTING APPLICATIONS INVOLVING THERMAL MANAGEMENT WITH SYNTHETIC JET EJECTORS”, and which is incorporated herein by reference in its entirety; and also claims the benefit of U.S. Provisional Application No. 61/801,702, filed Mar. 15, 2013, entitled “SINGLE PHASE ACTUATOR DRIVE CURRENT”, and which is incorporated herein by reference in its entirety; and also claims the benefit of U.S. Provisional Application No. 61/802,218, filed Mar. 15, 2013, entitled “THERMAL MANAGEMENT OF POWER SUPPLIES WITH SYNTHETIC JET EJECTORS”; and which is incorporated herein by reference in its entirety; and also claims the benefit of U.S. Provisional Application No. 61/806,146, filed Mar. 28, 2013, entitled “ACTUATOR CONTROL AND RESONANCE TRACKING USING ONLY BEMF MEASUREMENT”, and which is incorporated herein by reference in its entirety; and also claims the benefit of U.S. Provisional Application No. 61/787,831, filed Mar. 15, 2013, entitled “THERMAL MANAGEMENT DEVICE CONTAINING HEAT SPREADER EQUIPPED WITH HEAT PIPES AND INTEGRAL NOZZLES”, and which is incorporated herein by reference in its entirety; and also claims the benefit of U.S. Provisional Application No. 61/805,607, filed Mar. 27, 2013, entitled “MODULAR SYNTHETIC JET BASED THERMAL MANAGEMENT SYSTEM FOR SHROUDED OUTDOOR REMOTE RADIO HEAD UNITS”, and which is incorporated herein by reference in its entirety; and also claims the benefit of U.S. Provisional Application No. 61/843,399, filed Jul. 7, 2013, entitled “SYNTHETIC JET ACTUATORS AS MULTIFUNCTIONAL DEVICES IN MOBILE TECHNOLOGY PLATFORMS”, and which is incorporated herein by reference in its entirety; and also claims the benefit of U.S. Provisional Application No. 61/894,685, filed Oct. 23, 2013, entitled “SYNTHETIC JET ACTUATOR WITH VIBRATION CANCELLATION”, and which is incorporated herein by reference in its entirety.

### FIELD OF THE DISCLOSURE

The present disclosure relates generally to synthetic jet actuators, and more particularly to methods for forming synthetic jet actuators and components thereof through insert molding.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile thermal management solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques”.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System“; U.S. 20090084866 (Grimm et al.), entitled Vibration Balanced Synthetic Jet Ejector”; U.S. 20080295997 (Heffington et al.), entitled Synthetic Jet Ejector with Viewing Window and Temporal Aliasing”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled Vibration Isolation System for Synthetic Jet Devices”; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

### BRIEF DESCRIPTION OF THE DRAWINGS

FIGS. 1A-1C are illustrations depicting the manner in which a synthetic jet actuator operates.

FIG. 2 is an illustration of a particular, non-limiting embodiment of a conductive diaphragm for a synthetic jet ejector in accordance with the teachings herein.

FIG. 3 is an illustration, partially in section, of a particular, non-limiting embodiment of a diaphragm for a synthetic jet ejector in accordance with the teachings herein which has been co-molded with first and second O-rings.

FIGS. 4-9 are illustrations of a particular, non-limiting embodiment of a synthetic jet actuator assembly in accordance with the teachings herein which include a diaphragm which has been injection molded around a coil and a flexible printed circuit.

FIGS. 10-11 are illustrations of a particular, non-limiting embodiment of a method for injection molding the synthetic jet actuator assembly of FIGS. 4-9.

### SUMMARY OF THE DISCLOSURE

In one aspect, a synthetic jet ejector is provided which comprises (a) a power supply; (b) a voice coil; and (c) a diaphragm; wherein said diaphragm comprises a first portion which is dielectric, and wherein said diaphragm comprises a second portion which is electrically conductive, and wherein said second portion forms a conductive pathway between said power supply and said voice coil.

In another aspect, a device is provided which comprises (a) a voice coil; and (b) a diaphragm comprising an inner ring, an outer ring, and a surround which extends between said inner ring and said outer ring.

In a further aspect, a method for making a diaphragm is provided which comprises (a) providing a first ring having a first diameter and a second ring having a second diameter which is greater than said first diameter, wherein at least one of said first and second rings comprises a first elastomeric material; and (b) overmolding the first and second rings with a second material which is distinct from said first material, thereby forming a diaphragm.

In a further aspect, a method for making a synthetic jet ejector is provided. The method comprises (a) providing a bobbin assembly; and (b) insert molding a diaphragm around the bobbin assembly.

### DETAILED DESCRIPTION

Prior to further describing the systems and methodologies disclosed herein, a brief overview of synthetic jet actuators may be helpful. The operation of a synthetic jet ejector and the formation of a synthetic jet may be appreciated with respect to FIGS. 1A-1C. FIG. 1A depicts a synthetic jet actuator 10 comprising a housing 11 defining and enclosing an internal chamber 14. The housing 11 and chamber 14 may have virtually any geometric configuration, but for purposes of discussion and understanding, the housing 11 is shown in cross-section in FIG. 1A as having a rigid side wall 12, a rigid front wall 13, and a rear diaphragm 18 that is flexible to an extent to permit movement of the diaphragm 18 inwardly and outwardly relative to the chamber 14. The front wall 13 has an orifice 16 of any geometric shape. The orifice diametrically opposes the rear diaphragm 18 and connects the internal chamber 14 to an external environment having ambient fluid 39.

The flexible diaphragm 18 may be controlled to move by any suitable control system 24. For example, the diaphragm 18 may be equipped with a metal layer, and a metal electrode may be disposed adjacent to, but spaced apart from, the metal layer so that the diaphragm 18 may be moved via an electrical bias imposed between the electrode and the metal layer. Moreover, the generation of the electrical bias may be controlled by any suitable device, for example but not limited to, a computer, logic processor, or signal generator. The control system 24 may cause the diaphragm 18 to move periodically, or modulate in time-harmonic motion, and force fluid in and out of the orifice 16.

Alternatively, a piezoelectric actuator may be attached to the diaphragm 18. The control system would, in that case, cause the piezoelectric actuator to vibrate and thereby move the diaphragm 18 in a time-harmonic motion. The method of causing the diaphragm 18 to modulate is not specifically limited.

The operation of the synthetic jet actuator 10 may be appreciated with reference to FIGS. 1B and 1C. FIG. 1B depicts the synthetic jet actuator 10 as the diaphragm 18 is controlled to move inward into the chamber 14, as depicted by arrow 26. The volume of the chamber 14 is consequently decreased, thus causing fluid to be ejected through the orifice 16. As the fluid exits the chamber 14 through the orifice 16, the flow separates at sharp orifice edges 30 and creates vortex sheets 32 which roll into vortices 34 and begin to move away from the orifice edges 30 in the direction indicated by arrow 36.

FIG. 1C depicts the synthetic jet actuator 10 as the diaphragm 18 is caused to move outward with respect to the chamber 14, as depicted by arrow 38. The volume of the chamber 14 consequently increases and ambient fluid 39 rushes into the chamber 14, as depicted by the set of arrows 40. The diaphragm 18 is controlled by the control system 24 so that, when the diaphragm 18 moves away from the chamber 14, the vortices 34 are already removed from the orifice edges 30 and thus are not affected by the ambient fluid 39 being drawn into the chamber 14. Meanwhile, a jet of ambient fluid 39 is synthesized by the vortices 34, creating strong entrainment of ambient fluid drawn from large distances away from the orifice 16.

Despite the many advances in synthetic jet ejector technology, a need for further advances in this technology still exists. For example, due to design constraints or limitations imposed by a host device, it is difficult in some applications to provide a conductive pathway between the power supply and the voice coil of a synthetic jet ejector.

Another issue in synthetic jet ejector technology relates to diaphragm construction. In particular, many current diaphragm designs require the manufacturer to choose between snap-over features and diaphragm spring forces. There is thus a need in the art for a diaphragm design which allows these considerations to be optimized independently of each other.

A further issue in synthetic jet ejector technology relates to component assembly. In particular, current synthetic jet ejectors comprise various parts, such as bobbin assemblies and diaphragms, which must be assembled with respect to each other to yield the final product. This presents costs and difficulties from an assembly standpoint. There is thus a need in the art for a simplified method for assembling synthetic jet ejectors.

It has now been found that some or all of the foregoing needs may be addressed with the devices and methodologies disclosed herein. In preferred embodiments, these devices and methodologies utilize in-situ molding to produce synthetic jet ejectors, and components for the same, which overcome some or all of the aforementioned infirmities.

FIG. 2 illustrates a particular, non-limiting embodiment of a conductive diaphragm for a synthetic jet ejector which may be made by an in-situ molding process. The diaphragm 201 depicted therein has a first arcuate portion 205 comprising non-electrically conductive silicone, and a second arcuate portion 207 comprising electrically conductive silicone which serves as a conductive pathway between the power supply (not shown) and the voice coil 203. Since the diaphragm 201 provides a conductive pathway between the power supply and the voice coil 203, a diaphragm of this type may be useful in applications in which design or space constraints make the provision of a separate conductive pathway challenging. In a preferred embodiment, the power source is in electrical contact with the voice coil by way of a flexible printed circuit, as described with respect to the further embodiments disclosed below.

Several variations in the diaphragm of FIG. 2 are possible. For example, while the second (conductive) portion 207 of the diaphragm is depicted as having two conductive portions, diaphragms may be made in accordance with the teachings herein which have virtually any number of conductive portions. These conductive portions may be of various shapes and dimensions. For example, in some embodiments, the conductive portion may take the form of a web of conductive material which is disposed or printed on a surface of the diaphragm.

The diaphragm depicted in FIG. 2 may be made in a variety of ways. For example, the conductive portion may be printed onto a surface of the diaphragm using, for example, a conductive ink. The conductive portions may also be formed in a layer or film that is adhered or laminated to the diaphragm. Preferably, however, the diaphragm is formed either by placing the conductive portions in a mold and molding the diaphragm around them, by placing the remaining portions of the diaphragm in a mold and molding the conductive portions around them, or by co-molding the conductive portions and non-conductive portions of the diaphragm.

FIG. 3 depicts another particular, non-limiting embodiment of a diaphragm (partially in section) made in accordance with the teachings herein. As seen therein, the diaphragm 301 depicted is a snap-over type diaphragm which comprises a main membrane surround 303 which is overmolded onto first 305 and second 307 O-rings. This construction imparts greater design flexibility to the diaphragm 301 insofar as it decouples the mechanical requirements of the snap-over features from those of the diaphragm spring force.

In a preferred embodiment, the diaphragm 301 of FIG. 2 may be constructed by overmolding a liquid silicone rubber (LSR) diaphragm. In accordance with this approach, the individual pre-molded O-rings 305, 307 are placed into an LSR injection mold. The silicone rubber is then injected over and around the O-rings 305, 307 (and any other components of the device) to form the main membrane. The silicone rubber is then cured, after which the resulting article is removed from the mold. The O-rings may comprise various materials, but are preferably elastomeric materials such as nitrile rubber, butyl rubber, PTFE, silicone rubber or the like.

Other methodologies may also be utilized to fabricate the diaphragm 301 of FIG. 3. For example, the diaphragm 301 may be fabricated by a 2-shot LSR process in which a first, higher durometer LSR is injected into the portion of the mold which forms the snap-on features, and a second, lower durometer LSR is injected into the portion of the mold which forms the main membrane surround. The two materials then bond in the mold during cure of the second LSR.

While the foregoing approaches are especially suitable for forming diaphragms for synthetic jet ejectors, it will be appreciated that these approaches may be utilized to form a variety of diaphragms for various applications. For example, these approaches may be utilized to form diaphragms for loudspeakers and other linear actuators that require moving or flexible membranes.

As noted above, embodiments are possible in accordance with the teachings herein in which an electrically conductive component may be co-molded with a diaphragm. This concept may extended to other portions of the synthetic jet actuator as well. Thus, FIGS. 4-9 depict a particular, non-limiting embodiment of a synthetic jet actuator assembly 401 which includes a diaphragm 403, a (preferably plastic) bobbin 405, a coil 407 (see FIG. 7) and a flexible printed circuit 409, the latter of which may be in direct or indirect electrical contact with the coil 407. As seen therein, an LIM silicone diaphragm 403 is insert molded around the bobbin 405, coil 407 and a flexible printed circuit 409 to form a unitary construct which may then be removed from the mold (after suitable curing of the silicone) as a cohesive mass.

The manner in which the actuator assembly 401 of FIGS. 4-9 may be manufactured may be appreciated with respect to FIGS. 10-11. As seen therein, an actuator assembly 501 which includes a bobbin 505, a coil 507, and a flexible printed circuit 509 are placed in a mold 511. The mold 511 is complimentary in shape to the intended shape of the molded article, and in this particular embodiment includes first 513, second 515 and third 517 portions (see FIG. 11) which abut to form a tight seal around the flexible printed circuit 509. A vacuum is then applied which applies forces in the directions indicated by the arrows, and a suitable resin (which may preferably be cured or hardened) is injected into the mold cavity 519. Upon curing or hardening (which may include cooling, treatment with UV radiation, use of a chemical curing agent, or the like), the completed article is removed from the mold 511 as a cohesive mass.

Various materials may be utilized as molding compositions in the methodologies described herein. These include various silicones, silicone rubbers, nylons and other polymeric materials and resins. Various fillers and additives may be added to the foregoing including, for example, particulate fillers such as glass, sand or titanium dioxide, plasticizers, flame retardants, UV inhibitors, and the like.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A synthetic jet ejector, comprising:
a power supply;
a voice coil; and
a diaphragm;
wherein said diaphragm comprises a first portion which is dielectric, wherein said diaphragm comprises a second portion which is electrically conductive, and wherein said second portion forms a conductive pathway between said power supply and said voice coil.

2. The synthetic jet ejector of claim 1, wherein said second portion of said diaphragm comprises electrically conductive silicone, and wherein said first portion of said diaphragm comprise non-electrically conductive silicone.

3. The synthetic jet ejector of claim 1, wherein said power supply is in electrical contact with said conductive portion by way of a flexible printed circuit.

4. The synthetic jet ejector of claim 1, wherein said diaphragm has first and second opposing major surfaces, and wherein said second portion forms at least a portion of said first major surface.

5. The synthetic jet ejector of claim 4, wherein said power supply is in electrical contact with said conductive portion by way of a flexible printed circuit which extends from the second major surface of said diaphragm.

6. The synthetic jet ejector of claim 1, wherein said first portion is arcuate.

7. The synthetic jet ejector of claim 1, wherein said second portion is arcuate.

8. The synthetic jet ejector of claim 1, wherein said voice coil is disposed at the center of said diaphragm.

9. The synthetic jet ejector of claim 8, wherein said second portion extends from said voice coil to the edge of said diaphragm.

10. A device, comprising:
a voice coil; and
a diaphragm comprising an inner ring, an outer ring, and a surround which extends between said inner ring and said outer ring;
wherein said inner and outer rings comprise a first material, and wherein said surround comprises a second material which is distinct from said first material.

11. The device of claim 10, wherein said first material is an elastomer.

12. The device of claim 11, wherein said first material is selected from the group consisting of nitrile rubbers and PTFE.

13. The device of claim 10, wherein said second material is an elastomer.

14. The device of claim 10, wherein said second material is a silicone rubber.

15. The device of claim 10, wherein the device is a synthetic jet actuator.

16. The device of claim 10, wherein the inner ring and outer ring are O-rings.

17. The device of claim 10, wherein the inner ring and outer ring are radially attached to said surround.

18. The device of claim 10, wherein the material of the surround is overmolded over the inner ring and outer ring.

19. A method for making a diaphragm, comprising:
providing a first ring having a first diameter and a second ring having a second diameter which is greater than said first diameter, wherein at least one of said first and second rings comprises a first elastomeric material; and
overmolding the first and second rings with a second material which is distinct from said first material, thereby forming a diaphragm.

20. The method of claim 19, wherein overmolding the first and second rings includes:
placing the first and second rings in a mold;
injecting the second material into the mold; and
curing the second material.

21. The method of claim 19, further comprising:
removing the first and second rings and the second material from the mold as a cohesive mass.

22. The method of claim 21, further comprising:
incorporating the cohesive mass into a synthetic jet ejector.

23. The method of claim 21, wherein overmolding the first and second rings with the second material forms a surround which extends from said first ring to said second ring.

24. A method for making a synthetic jet actuator, comprising:
providing a bobbin assembly; and
insert molding a diaphragm around the bobbin assembly.

25. The method of claim 24, wherein the bobbin assembly includes a voice coil and a flexible circuit which is in electrical contact with said voice coil.

26. The method of claim 24, wherein the diaphragm is a silicone diaphragm.

27. The method of claim 24, wherein insert molding a diaphragm around the bobbin assembly includes:
placing the bobbin assembly into a mold;
injection a material into the mold;
curing the material; and
removing the cured material and the bobbin assembly from the mold as a cohesive mass.
